(19) United States
(12) Patent Application Publication
(10) Pub. No.: US 2009/0133451 A1
(43) Pub. Date: May 28, 2009

(54) LOCKING MECHANISM AND LOCKING APPARATUS

(76) Inventor: Robert Standar, Pretzfeld (DE)

Correspondence Address: BRINKS HOFER GILSON & LIONE, P.O. BOX 10395, CHICAGO, IL, 60610, US

(21) Appl. No.: 12/275,664

(22) Filed: Nov. 21, 2008

(30) Foreign Application Priority Data
Nov. 28, 2007 (DE) DE102007057288.5

(51) Int. Cl. G05G 5/00

(52) U.S. Cl. 70/174

(57) ABSTRACT

A locking apparatus with a locking system housing is provided. The locking system housing includes at least one sliding pad and a locking pad with at least one locking groove. The at least one sliding pad and the locking pad are arranged in such a manner that they may be displaced by at least or counter to at least a first spring.

The present patent document claims the benefit of the filing date of DE 10 2007 057 288.5, filed Nov. 28, 2007, which is hereby incorporated by reference.

### BACKGROUND

Design engineers, in different areas of technology, are faced with deploying locking mechanisms that correspond to the respective situation and which allow simple but effective and reliable locking and unlocking of a mechanical connection between structural parts of a structure. The solution that is appropriate in each instance is a function of the requirements of the situation with regard to mechanical loading capacity, safety, operating capacity and similar criteria.

A mammography device, for example, includes a compression plate that is connected to a mammography device mechanically in such a manner that the connection can be subjected to the compressive forces that typically occur in a mammography process but can at the same time be locked and unlocked in a reliable and simple manner. A compression plate may be positioned on the compression unit and removed with one hand. Accordingly, the compression plate must be locked securely in the compression unit when in the positioned state and it must also not be able to move under load.

### SUMMARY

The present embodiments may obviate one or more of the problems or drawbacks inherent in the related art. For example, in one embodiment, a locking mechanism includes a locking pad for locking purposes. The locking pad includes at least one locking groove. At least one sliding pad, which is disposed in a locking system housing, is displaced counter to at least a first spring. Accordingly, at least one blocking body, driven by at least a second spring, enters the at least one locking groove, thereby fixing the locking pad in position.

In another embodiment, a locking mechanism includes a locking button for unlocking purposes. The locking button may be displaced counter to at least a second spring. Accordingly, at least one blocking body is pushed out of at least one locking groove of a locking pad, in that at least one sliding pad, driven by at least a first spring, displaces the locking pad.

### BRIEF DESCRIPTION OF THE DRAWINGS

FIG. 1 illustrates one embodiment of a locking system housing with a locking button;

FIG. 2 illustrates one embodiment of a process of positioning a compression plate in a locking mechanism;

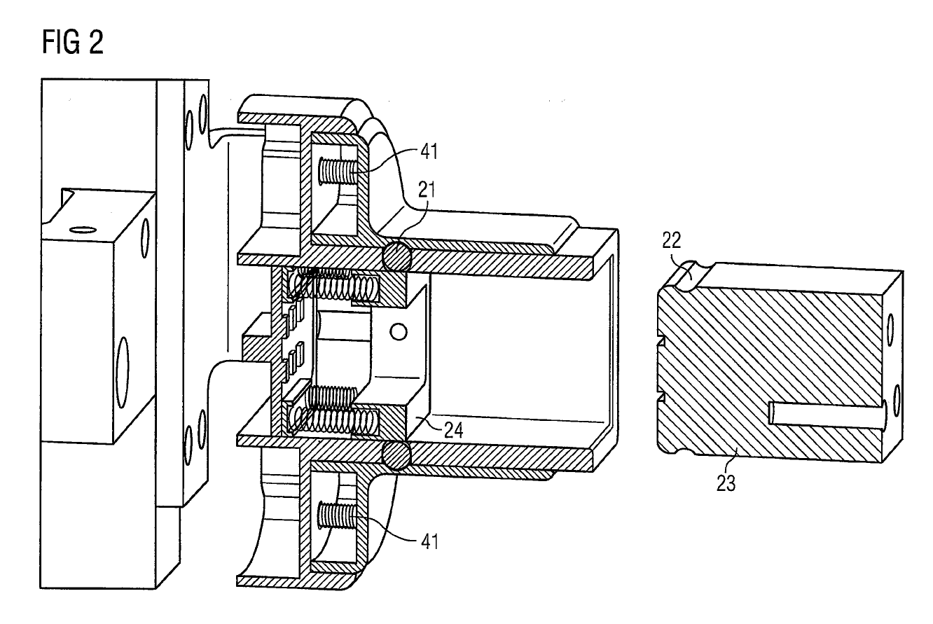

FIG. 3 illustrates one embodiment of a locking mechanism with a positioned compression plate; and

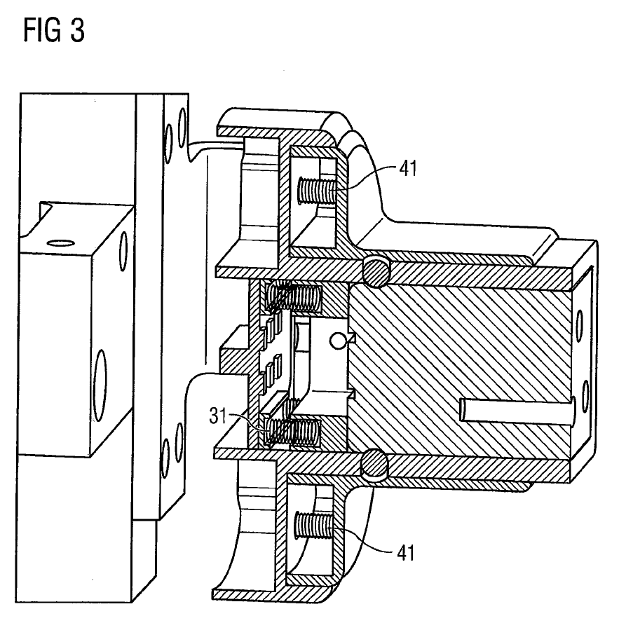

FIG. 4 illustrates a locking mechanism with a locked compression plate.

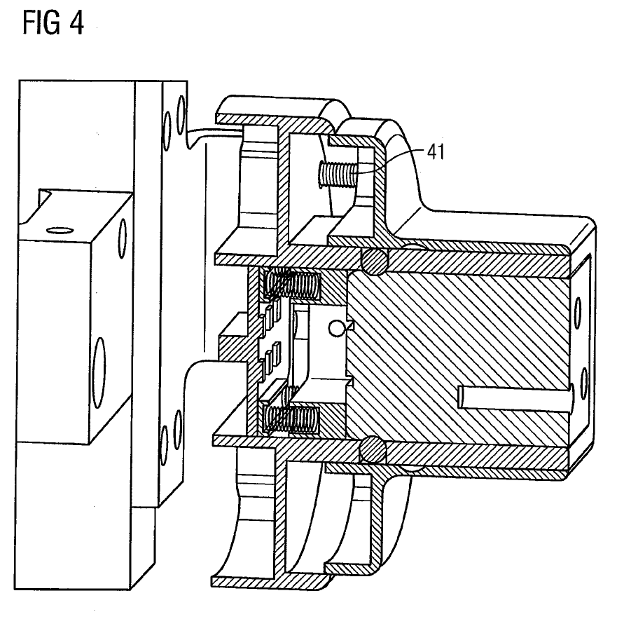

### DETAILED DESCRIPTION

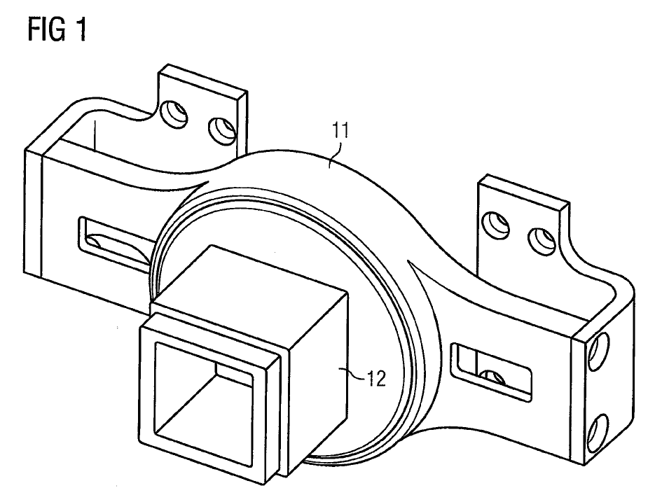

FIG. 1 illustrates a locking mechanism that may be used locking purposes. For locking purposes, the locking mechanism may include a locking pad (23) with at least one locking groove (22). The locking pad (23) may displace at least one sliding pad (24) into a locking system housing (11) counter to at least a first spring (31). Accordingly, at least one blocking body (21), driven by at least a second spring (41), may enter the at least one locking groove (22), thereby fixing the locking pad in position.

The locking mechanism may include a locking button (12). For unlocking purposes, the locking button (12) may be displaced counter to at least a second spring (41). Accordingly, at least one blocking body (21) may be pushed out of at least one locking groove (22) of a locking pad (23), such that at least one sliding pad (24), driven by at least a first spring (31), displaces the locking pad (23).

In one embodiment, the features described above for locking and unlocking purposes are combined.

The locking mechanism may include a locking apparatus with a locking system housing (11). The locking system housing (11) may include at least one sliding pad (24) and a locking pad (23) with at least one locking groove (22). The at least one sliding pad (24) and locking pad (23) may be arranged in such a manner that they can be displaced by at least or counter to at least a first spring (31).

The locking apparatus may include at least one blocking body (21), which is arranged in the locking system housing (11) in such a manner that for locking purposes it is driven by at least a second spring (41) to enter the at least one locking groove (22), thereby fixing the locking pad (23) in position.

In one embodiment, a locking apparatus includes at least one blocking body (21). The at least one blocking body (21) may be arranged in the locking system housing (11) in such a manner that for unlocking purposes, when a locking button (12) is displaced counter to at least a second spring (41), the at least one blocking body (21) is pushed out of at least one locking groove (22) of a locking pad (23). Accordingly, the at least one sliding pad (24), driven by at least a first spring (31), may displace the locking pad (23).

In one embodiment, a locking apparatus combines all the above-mentioned solution features.

The described first or second springs may be replaced by equivalent elastic forces. The at least one blocking body (21) may be spheres, for example, made of steel. Alternatively, the at least one blocking body (21) may be cylindrical rods or similar blocking bodies, which can carry out the described function in an equivalent manner.

The present embodiments may be described in greater detail below using an example from medical engineering, specifically that of the locking system of a compression plate on a mammography device. A locking pad, at the top and bottom of which a locking groove for the spheres is machined, is present on the compression plate. A locking system housing is present on the compression unit. A latching mechanism is present in the locking system housing.

During insertion of the compression plate, a sliding pad may be pushed backward. Accordingly, the four steel spheres supported in the locking system housing and the locking button are released forward by way of springs. Until being released, the four steel spheres and locking button had been locked by the steel balls. The steel spheres drop into the locking pad at this point and fix it in position. The compression plate may be connected to the compression unit in a form-fit manner by the square end without any gap.

During removal of the compression plate, the entire process may be reversed. Pressing the locking button causes the steel spheres to fall into the free space and the sliding pad is pushed forward by springs and the steel spheres are fixed securely in the button. The compression plate is pushed outward a short way over the sliding pad and can be removed.

This present embodiments may allow one-handed operation when positioning and removing the compression plate. The resulting form-fit connection is secured against twisting. The steel sphere mechanism described above ensures an extremely secure locking system. There is no risk that the compression plate will be displaced even subject to the action of a force. The compression plate may be unlocked by the unlocking button from all positions of the system.

1. A locking mechanism comprising:
a locking pad with at least one locking groove, the locking pad being operable to displace at least one sliding pad in a locking system housing counter a first spring for locking purposes, such that at least one blocking body, driven by a second spring, enters the at least one locking groove, thereby fixing the locking pad in a position.

2. A locking mechanism comprising:
a locking button that is operable to be displaced counter to at least a second spring for unlocking purposes,
wherein at least one blocking body is operable to be pushed out of at least one locking groove of a locking pad, such that at least one sliding pad, driven by at least a first spring, displaces the locking pad.

3. The locking mechanism of claim 1, further comprising a locking button that is operable to be displaced counter to the second spring for unlocking purposes, the at least one blocking body being operable to be pushed out of the at least one locking groove of the locking pad, such that the at least one sliding pad, driven by at least the first spring, displaces the locking pad.

4. A locking system, comprising:
a locking system housing having at least one sliding pad and a locking pad with at least one locking groove, the at least one sliding pad and the locking pad being arranged in such a manner that they can be displaced by or counter to a first spring.

5. The locking system as claimed in claim 4, comprising at least one blocking body, which is arranged in the locking system housing (11) in such a manner that for locking purposes it is driven by at least a second spring to enter the at least one locking groove, thereby fixing the locking pad in position.

6. The locking system as claimed in claim 4, further comprising at least one blocking body, which is arranged in the locking system housing in such a manner that for unlocking purposes, when a locking button is displaced counter to at least a second spring, the at least one blocking body is pushed out of at least one locking groove of a locking pad, such that at least one sliding pad, driven by the first spring, displaces the locking pad.

7. A locking system as claimed in claim 4, comprising at least one blocking body, which is arranged in the locking system housing in such a manner that for locking purposes it is driven by at least a second spring to enter the at least one locking groove, thereby fixing the locking pad in position,
wherein the at least one blocking body is pushed out of the at least one locking groove of a locking pad, such that at least one sliding pad when a locking button is displaced counter to at least a second spring, such that the locking pad is displaced.
